(19) United States
(12) Patent Application Publication
(10) Pub. No.: US 2012/0317997 A1
(43) Pub. Date: Dec. 20, 2012

(54) CONVERSION OF LIQUEFIED NATURAL GAS

(75) Inventors: Josef Pozivil, Allschwil (CH); David De Nardis, Kintzheim (FR)

(73) Assignee: Cryostar SAS, Hesingue (FR)

(21) Appl. No.: 13/500,717

(22) PCT Filed: Oct. 8, 2010
(86) PCT No.: PCT/EP2010/065079

§ 371 Date: Jun. 11, 2012

(30) Foreign Application Priority Data
Oct. 9, 2009 (EP) 09352005.4

(51) Int. Cl. F17C 9/02; F17C 13/08

(52) U.S. Cl. 62/50.2; 62/53.2

(57) ABSTRACT

Liquefied Natural Gas (LNG) is converted to a superheated fluid at a temperature greater than 5° C. by being passed under pressure through a train of first, second and third main heat exchange stages in series, in which the natural gas is heated by a circulating heat exchange fluid flowing in heat exchange circuits. The heat exchange fluid condenses in the first and second heat exchange stages and is partially vaporised in subsidiary heat exchangers which may be heated by sea water flowing in open cycle.

### BACKGROUND

The present invention relates to a method and apparatus for converting liquefied natural gas to a superheated fluid. The method and apparatus are particularly suited for use on board a ship or other ocean-going vessel, for example, an FSRU (Floating Storage and Regasification Unit).

Natural gas is conveniently stored and transported in liquid state. It is generally used, however, in gaseous state. There is therefore a need to convert large volumes of liquefied natural gas to a superheated fluid, typically a gas below the critical pressure of natural gas, but sometimes a fluid at a pressure above the critical pressure.

U.S. Pat. No. 6,945,049 discloses a method and apparatus for vaporising liquefied natural gas. Liquefied natural gas is pumped through a first heat exchanger to effect vaporisation and a second heat exchanger to raise the temperature of the vapour to approximately ambient temperature, or a little below ambient temperature. The first heat exchanger is heated by a heat exchange fluid, such as propane, flowing in a closed cycle. The propane changes from gaseous to liquid state in the first heat exchanger and is converted to a gas again in a plurality of heat exchangers which are typically heated by a flow of sea water. In the second heat exchanger, the vaporiser natural gas is heated by a flow of steam.

Particular demands upon the heating method and apparatus are made for the natural gases required at a temperature of greater than 5° C., for example, in the order of 10° to 25° C.

The present invention provides a method and apparatus aimed at meeting these demands.

### SUMMARY OF THE INVENTION

According to the present invention, there is provided a method of converting liquefied natural gas to a superheated fluid having a temperature greater than 5° C., comprising the steps of passing the natural gas under pressure through a train of first, second and third heat exchange stages in series in which the natural gas is heated, wherein each main heat exchange stage is heated by a condensing heat exchange medium, or the first and second main heat exchange stages are heated by a condensing heat exchange medium, the third main heat exchange stage being heated by a liquid medium which does not change phase in the third main heat exchange stage, wherein each main heat exchange stage that is heated by a condensing heat exchange medium has said heat exchange medium flow in an endless circuit comprising in addition to the main heat exchange stage, a vessel for collecting condensed heat exchange medium from the main heat exchanger, at least one subsidiary heat exchanger for revaporising the condensed heat exchange medium and a pump for pressurising a flow of the condensed heat exchange medium, the pump being located intermediate an outlet from the collection vessel and the subsidiary heat exchanger, and wherein the natural gas is raised to a temperature in the range of minus 40° C. to minus 20° C. in the first main heat exchange stage, to a temperature in the range of minus 5° C. to plus 5° C. in the second main heat exchange stage and to a temperature in the range of 10° C. to 25° C. in the third heat exchange stage.

The present invention also provides apparatus for converting liquefied gas to a superheated fluid having a temperature greater than 5° C. comprising a train of first, second and third main heat exchanger stages in series.

It is to be understood, with reference to the direction of natural gas flow, that the most upstream of the heat exchange stages is the first heat exchange stage, the intermediate one the second heat exchange stage, and the most downstream one the third heat exchange stage. Each main heat exchange preferably comprises a discrete heat exchanger.

Each main heat exchange stage may be heated by a condensing heat exchange medium. The composition of the heat exchange medium may be the same in each main heat exchange stage, different condensing pressures being employed so as to give a required gradation in the natural gas outlet temperature of each main heat exchange stage in the series. Alternatively, only the first and second main heat exchange stages may be heated by a condensing heat exchange medium, the third heat exchange stage being heated by a liquid medium such as water, for example sea water, or a mixture of water and glycol in a closed circuit, which does not change phase in the third main heat exchange stage.

The condensing heat exchange medium used to heat any particular main heat exchange stage may flow in an endless circuit comprising in addition to the main heat exchange stage, a vessel for collecting condensed heat exchange medium from the main heat exchanger, at least one subsidiary heat exchanger for revaporising the condensed heat exchange medium and a pump for pressurising a flow of the condensed heat exchange medium, the pump being located intermediate an outlet from the collection vessel and the subsidiary heat exchanger. The first and second main heat exchange stages, in particular, preferably both form part of such a circuit.

If desired, two heat exchange circuits may share a common collection vessel. The subsidiary heat exchanger in the heat exchange circuit that includes the first main heat exchange stage may be heated by seawater. So may the subsidiary heat exchanger in that the heat exchange circuit that includes the second main heat exchange stage.

If a condensing heat exchange medium is employed to heat the third main heat exchange stage, the third main heat exchange stage may form part of a heat exchange circuit of the kind described above. A subsidiary heat exchanger in this heat exchange circuit is preferably heated by a source of water or a mixture of water and glycol that flows in a closed circuit and that has been used to capture waste heat from, for example, an engine or from combustion gases. If there is no waste heat readily available, a heat pump may be used to raise the temperature of the flowing liquid, (the water or water-glycol mixture) to a desired higher temperature and so as to provide necessary heating of the heat exchange medium in the heat exchange circuit. A less preferred alternative is to operate a boiler to raise steam and to employ the resultant steam to raise the temperature of the heat exchange medium. Typically, the third heat exchanger meets no more than 5% of the total load on the main heat exchange stages, and therefore the operational cost of this heating is kept down.

Typically the heat exchange circuit that includes the first heat exchanger may employ two or more subsidiary heat exchangers in parallel in order to meet the thermal load on it. Propane is a preferred choice for the heat exchange medium in all of the heat exchange circuits, particularly the ones including the first main heat exchange stage and the second main heat exchange stage. Propane is readily available commercially and has thermodynamic properties that enable the condensing temperatures in the three main heat exchangers each to be selected in the range −40° C. to +25° C. Other heat exchange fluids may be used instead of or in a mixture with propane. Such alternative or additional heat exchange fluids comprise ethane, butane and fluorocarbon refrigerants, particularly R134(a).

The first heat exchange circuit typically raises the natural gas to a temperature in the range −40° C. to −20° C. The second heat exchange circuit typically raises the natural gas to a temperature in the range −5° C. to +5° C. The third heat exchange circuit may raise the natural gas to its desired final temperature, typically in the order of +10° C. to +25° C.

If desired, depending on the maximum rate of supply of natural gas, the method and apparatus according to the present invention may employ a plurality of said trains in parallel.

Another alternative is for two trains to share a third main heat exchange stage. In one example, there are four trains sharing two third main heat exchange stages. In general, any number of said trains may share any number of third heat exchange stages.

A yet further alternative is for two trains to share second and third main heat exchange stages. In a further example, there are four main heat exchange stages in parallel communicating with first and second pairs of second and third main heat exchange stages. In general, any number of said trasins may share any number of second and third heat exchange stages.

If desired, one train may exchange natural gas with another train.

The apparatus and method according to the present invention may be located and performed aboard a sea going vessel, for example, a so-called FSRU (Floating Storage and Regasification Unit).

The heat exchange medium in any or all of the heat exchange circuits may be partially vaporised in its subsidiary heat exchanger or heat exchangers. If partially vaporised, the residual liquid may be disengaged from the resultant vapour in, for example, a disengagement vessel fitted with suitable liquid-vapour disengagement means.

### BRIEF DESCRIPTION OF THE DRAWINGS

The method and apparatus according to the present invention will now be described by way of example with reference to the accompanying drawings in which:

FIG. 1 is a flow diagram of a first apparatus for use in the method according to the invention;

FIG. 2 is a schematic representation of the apparatus shown in FIG. 1;

FIG. 3 is a schematic representation of a second apparatus for use in the method according to the invention;

FIG. 4 is a schematic representation of a third apparatus for use in the method according to the invention; and

FIG. 5 is a flow diagram of an alternative to the first apparatus for use in the method according to the invention.

### DESCRIPTION OF THE INVENTION

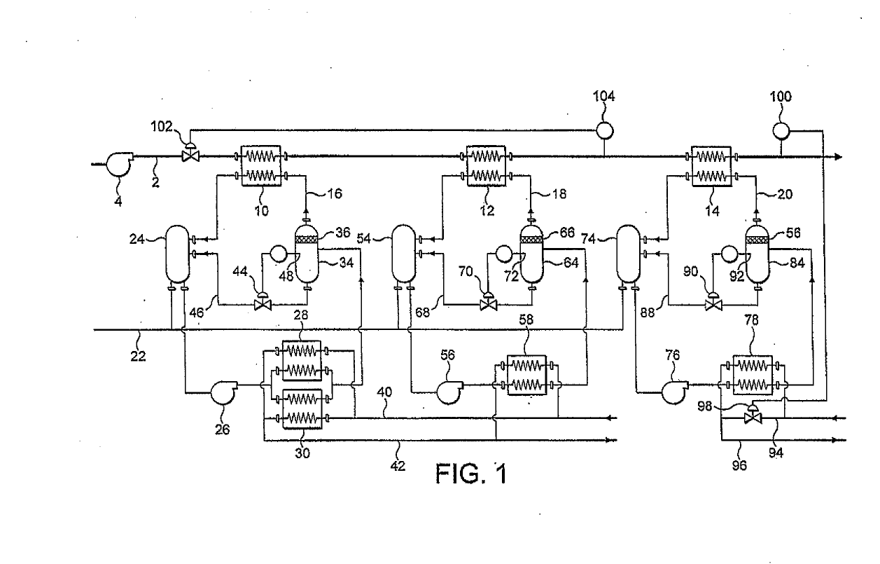

Referring to FIG. 1, conduit 2 has disposed therealong an LNG pump 4. The pump 4 may be capable of raising the pressure of the LNG to 100 bar or more depending on user demand. The conduit 2 communicates at its inner end with an LNG facility (not shown), which typically comprises at least one thermally-insulated storage tank (not shown) having a submerged LNG pump (not shown). The submerged LNG pump is in operation able to transfer LNG to the conduit 2.

The outlet of the pump 4 communicates with an apparatus according to the invention for heating the flow of LNG. The apparatus and the storage tanks are typically located aboard a sea going vessel, which may, for example, be a so-called FSRU (Floating Storage and Regasification Unit). There is from time-to-time a need to deliver natural gas from the apparatus at elevated pressure and a non-cryogenic temperature, in the case of the present invention, at a temperature not less than +15° C. The apparatus illustrated in FIG. 1 enables a natural gas to be delivered at a chosen pressure, rate and temperature. This apparatus includes a first main heat exchanger 10, a second main heat exchanger 12 and a third main heat exchanger 14. The first main heat exchanger 10, the second main heat exchanger 12 and the third main heat exchanger 14 are heated by condensing heat exchange fluid flowing in, respectively, a first heat exchange circuit 16, a second heat exchange circuit 18 and a third heat exchange circuit 20. The heat exchange circuits 16, 18 and 20 are all endless but are fed with heat exchange fluid in the liquid state from a common pipeline 22.

The first heat exchange circuit 16 includes a heat exchange liquid tank 24 which may receive an initial batch of heat exchange liquid and any top-up liquid from the pipeline 22. The liquid pump 26 is operable to withdraw heat exchange liquid from the tank 24 and to pass it to two parallel first subsidiary heat exchangers 28 and 30. The heat exchange liquid is partially vaporised as it passes through the heat exchangers 28 and 30. The resulting partly vaporised heat exchange liquid flows to a liquid-vapour disengagement vessel 34 with a suitable demister or other liquid-vapour disengagement means 36. Disengaged liquid is returned to the collection tank 24. Vapour flows through the first main heat exchanger 10 countercurrently or cocurrently to the flow of natural gas.

Sufficient flow of the heat exchange fluid is provided through the first main heat exchanger 10 so as to vaporise all the liquefied natural gas flowing therethrough and to superheat it to a chosen temperature typically in the range −20° to −40° C. It is to be appreciated, however, that the pump may typically raise the pressure of liquefied natural gas to above its critical pressure, say to about 100 bar, in which case, the natural gas enters the first main heat exchanger 10 as a supercritical fluid, so strictly speaking it is not vaporised. The pressure in the heat exchange circuit can adjust by itself according to the temperature of the heat exchange fluid, the thermal load on the first main heat exchanger 10, the heat exchange surface area provided in the first main heat exchanger 10, the temperature difference between the stream being cooled and the stream being heated in the first main heat exchanger 10, and the heat transfer coefficient. In general, the cooling circuit 16 is required to meet 70% to 80% of the thermal load on the entire apparatus. It is for this reason that two subsidiary first exchangers 28 and 30 are used.

The first heat exchange medium liquid is propane. Propane is readily available commercially and has thermodynamic properties that enable the condensing temperature in the first heat exchanger to vary or “self adjust” in the range −20° C. to 0° C.

The heat exchange medium or liquid is typically vaporised in the first subsidiary heat exchangers 28 and 30 in indirect heat exchange with a flow of sea water taken from a first main 40 and returned to a second main 42. The sea water typically flows in open circuit. The temperature of the sea water may vary seasonally or diurnally in the range 5° C. to 13° C. and it will typically be cooled by approximately 7 to 9° C. by passage through the first subsidiary heat exchangers 28 and 30. The sea water is of course readily available on board a ship or other sea-going vessel.

A flow control valve 44 is located in a conduit 46 through which liquid is returned from the disengagement vessel 34 to the tank 24. The flow control valve 44 is operatively associated with a level detector 48 in the vessel 34 and its position is adjusted as necessary so as to maintain a constant liquid propane level in the vessel 34.

The second heat exchange circuit 18 is similar to the first. It includes a liquid heat exchange medium collection tank 54 in which liquid may be withdrawn by operation of a pump 56. The pump sends the liquid heat exchange medium through a single second subsidiary heat exchanger 58 in which it is partially vaporised. The resulting partially vaporised heat exchange medium flows into a liquid-vapour disengagement vessel 64 containing a demister pad 66. The vapour from which the liquid has been disengaged flows through the second main heat exchanger 12 countercurrently to cocurrently with the natural gas flow and provides further heating for the natural gas, the vapour itself condensing in the second main heat exchanger 12. Typically, the natural gas is raised in the second main heat exchanger 12 to a temperature of about 0° C. The heat exchange medium condenses in the second main heat exchanger 12 and the resulting condensate returns to the collection tank 54. Liquid disengaged from the vapour in the vessel 64 is returned to the collection tank 54 through a conduit 68. A flow control valve 70 is located in the conduit 68. The flow control valve 70 responds to signals from a level sensor 72 in the vessel 64 so as to maintain a constant level of liquid refrigerant therein. The second subsidiary heat exchanger 58 is heated by means of sea water from the main 40. The resulting cooled sea water is returned to the main 42.

The heat exchange medium used in the second heat exchange circuit 18 is preferably the same heat exchange medium as used in the first heat exchange circuit 16. Thus, it may be propane. Propane readily condenses at −5 to +5° C. The condensing pressure in the second heat exchange circuit 18 is higher than that in the first heat exchange circuit 16. Typically, the second heat exchanger 18 meets from 15% to 20% of the total thermal load on the apparatus.

The third heat exchange circuit 20 is similar to the first and second heat exchange circuits 16 and 18. It contains a liquid collection tank 74 which prior to start-up may be fed with liquid heat exchange medium from the pipeline 22. The pump 76 withdraws liquid from tank 74 and passes it through a third subsidiary heat exchanger 78. Passage of the liquid heat exchange medium through the heat exchanger 78 results in its partial vaporisation. The resulting partially vaporised liquid flows into liquid-vapour disengagement vessel 84 fitted with a demister 56. Liquid is disengaged from vapour in the vessel 84. The disengaged vapour flows through the third main heat exchanger 14 in countercurrent or cocurrent heat exchange with the natural gas and raises the temperature of the natural gas to a desired delivery temperature of for example +15° C. The vaporous heat exchange medium is condensed in the heat exchanger 14. The resulting condensate flows back to the collection tank 74. The disengaged liquid flows from the vessel 84 through a conduit 88 to the collection tank 74. A flow control valve 90 is located in the conduit 88. The valve 90 is operatively associated with a level sensor 92 in the vessel 84, the arrangement being such that a constant level of liquid heat exchange medium is able to be maintained in the vessel 84 during operation of the apparatus. Typically, sea water is not used to heat the third subsidiary heat exchanger 78. Instead, a source of warm water or water-glycol mixture that has been used to capture waste heat may be employed. Water flows to the third subsidiary heat exchanger 78 through a pipeline 94, and, downstream of having been cooled therein, flows out of the third subsidiary heat exchanger 78 into another pipeline 96. The pipelines 94, 96 may be in closed circuit.

The thermal load on the third heat exchange circuit 20 is typically much less than that on either the first heat exchange circuit 16 or the second heat exchange circuit 18. The liquid heat exchange medium employed in the third heat exchange circuit 20 may be the same as that employed in the first heat exchange circuit 16 and the second heat exchange circuit 18. Thus, propane may be used as the heat exchange medium in the third heat exchange circuit 20. It will still condense in the range +15° C. to +30° C., but at a higher pressure than in the second heat exchange circuit 18.

Temperature control of the natural gas delivered from the conduit 2 may be exerted by adjusting the setting of a flow control valve 98 in the pipeline 94 in response to a temperature sensor 100 positioned in the conduit 2 downstream of the passage of the natural gas through the third main heat exchanger 14. If the temperature is too low, the setting of the valve 98 may be adjusted to increase the flow of warm heating medium therethrough. In addition, a flow control valve 102 may be provided in the conduit 2 upstream of the first main heat exchanger 10. Valve 102 may be controlled in response to signals from a temperature sensor 104 at a position in the conduit 2 intermediate the second main heat exchanger 12 and the third main heat exchanger 14.

One control strategy is to specify a demand flow and an inlet sea water temperature for a desired temperature sensed by the sensor 104. If the sensed temperature becomes too low, the temperature signal will override a flow demand control and adjust the setting of the valve 102 to reduce the LNG flow. For example, if the inlet sea water temperature is lower than specified or the inlet flow of LNG higher than specified, the temperature sensor 104 will send signals causing the valve 102 to reduce the LNG flow. If, on the other hand, the sea water inlet temperature is higher than specified, the LNG flow can be increased above the specified valve. For a lower than specified inlet flow of LNG, the temperature sensed by the sensor 104 will be higher and the control system is arranged so that the temperature control does not override the flow control, and the temperature sensed by the sensor 104 is allowed to slide to higher values.

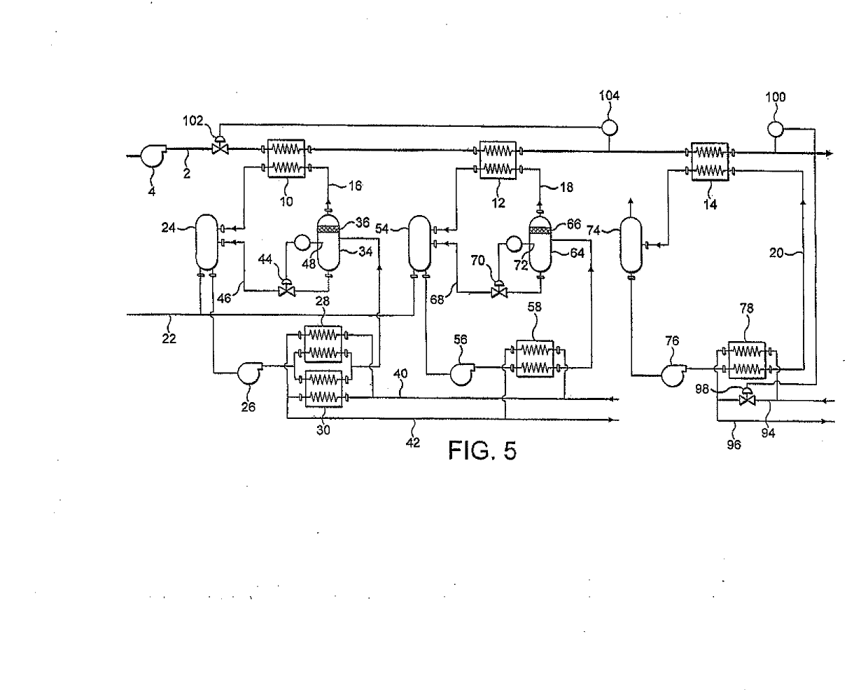

Various changes and modifications may be made to the apparatus shown in FIG. 1. In particular, because the third heat exchange circuit 20 is typically required to meet less than 5% of the total thermal load on the apparatus, it may be simplified by employing water or a water-glycol mixture to heat the third main heat exchanger 14. Such an arrangement is shown in FIG. 5. Parts in FIG. 5 that are essentially the same as corresponding parts shown in FIG. 1 are indicated by the same reference numerals as in FIG. 1, and reference should be made to the description of FIG. 1 to understand their operation.

Referring to FIG. 5, the third heat exchange circuit 20 deploys liquid water or water-glycol mixture throughout as the heat exchange medium. There is no change of phase of the liquid in either the third main heat exchanger 14 or the third subsidiary heat exchanger 78. Relatively cold water is collected in the vessel 74 from the third main heat exchanger 14 and is passed by pump 76 through the third subsidiary heat exchanger 78 in which it is reheated by heat exchange with relatively warm water or other heating medium. The reheated water flows directly from the third subsidiary heat exchanger 78 to the third main heat exchanger 14 in order to heat the natural gas to the required temperature in the order of +10° C. to +25° C. The water is cooled by the heat exchange and forms the water that goes to the collection tank 74. Although the third heat exchange circuit 20 is less thermally efficient than the corresponding circuit 20 in the apparatus shown in FIG. 1, the overall effect on the thermal efficiency of the apparatus as a whole is small because of the relatively low thermal load on the third heat exchange circuit 20.

A further modification to the apparatus shown in FIG. 1 is that instead of using two collection tanks 24 and 54, a single common collection tank (not shown) may be used instead.

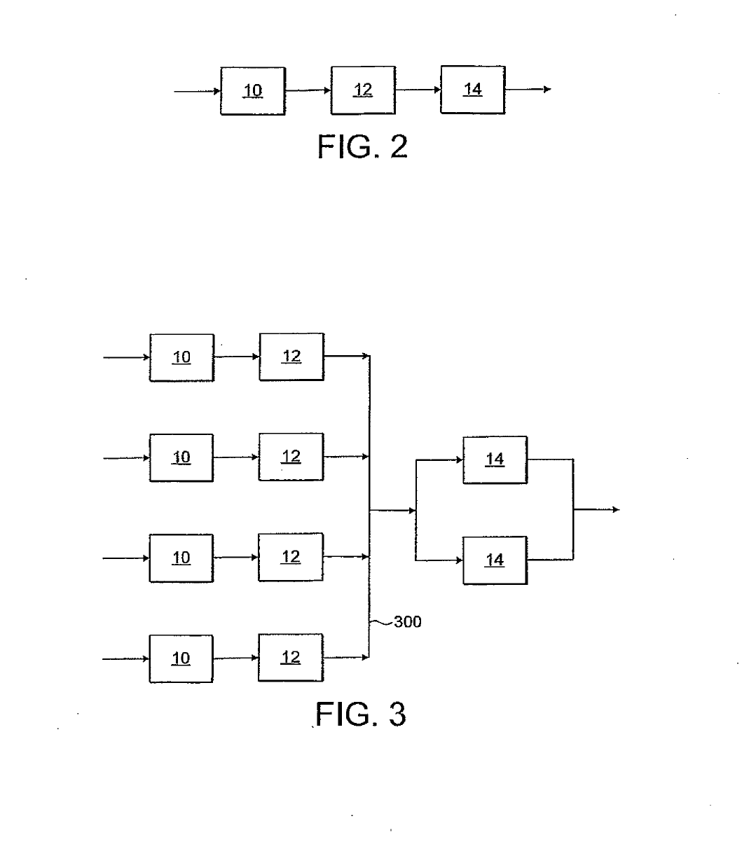

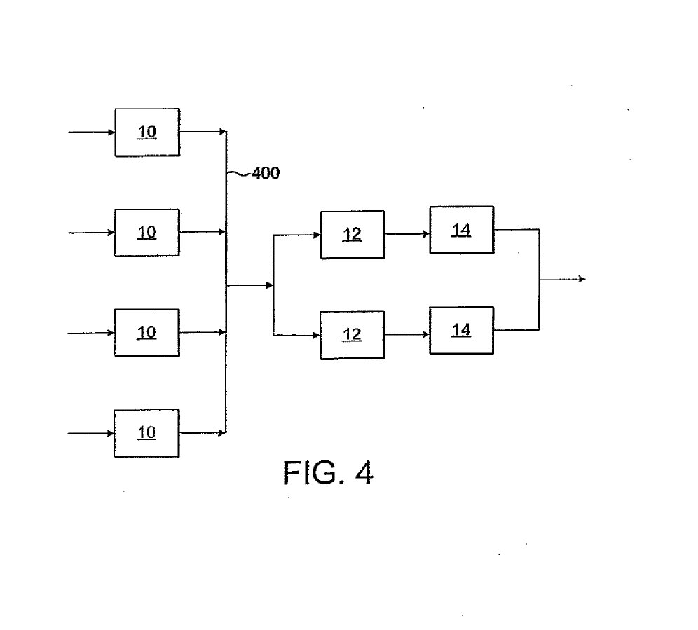

Referring now to FIG. 2, there is shown a simplified representation of the same apparatus as that shown in FIG. 1. The same kind of simplification is used in FIGS. 3 and 4 which illustrate apparatus intended to handle a greater rate of flow of LNG than the apparatus shown in FIG. 1 or FIG. 5.

FIG. 3 illustrates an apparatus according to the invention which employs a plurality of trains of first heat exchanger 10, second heat exchanger 12 and third heat exchanger 14. The apparatus shown in FIG. 3 employs four first main heat exchangers 10 in parallel. Each first main heat exchanger 10 communicates with a second main heat exchanger 12. There are therefore four second main heat exchangers 12 in parallel. In this example, it is desirable to operate the third main heat exchanger 14 with a relatively higher thermal load than that on the corresponding main heat exchanger 14 shown in FIG. 1. Accordingly, in the apparatus shown in FIG. 3, there are just two third main heat exchangers 14 in parallel. Heated natural gas from each of the second main heat exchangers 12 flows into a common distributor pipe 300. The natural gas is distributed therefrom to the two third main heat exchangers 14. Each of the main heat exchangers may be operated and provided with heating in the same manner as the corresponding heat exchangers in the apparatus shown in FIG. 1.

FIG. 4 shows a further modification. Now there are still four first main heat exchangers 10 in parallel, but each of these heat exchangers conducts heated natural gas to a common distributor pipe 400 which in turn conducts the heated natural gas to an arrangement of two second main heat exchangers 12 in parallel. Natural gas flows from both of the second main heat exchangers 12 to their own third main heat exchanger 14. There are thus two third main heat exchangers 14 in parallel. The main first main heat exchangers 10, the second main heat exchangers 12 and the third heat exchangers 14 may be of the same kinds as the corresponding heat exchangers in the apparatus shown in FIG. 1.

The trains with selected different combinations of main heat exchangers 10, 12 and 14, as shown in FIGS. 2, 3 and 4, and the respective heat exchange circuits 16, 18 and 20 can both be sized in accordance with the redundancy needs of the entire natural gas supply apparatus.

A method and apparatus according to the invention are particularly advantageous in that use of the third main heat exchanger(s) 14 makes possible a considerable gain in operating efficiency. The thermal load on the first and second main heat exchangers 10 and 12 may be maximised; the heat exchange circuits 16 and 18 may be heated by sea water flowing in open cycle, and the heat exchange circuit 20 may be heated by heating medium in closed cycle.

1. A method of converting liquefied natural gas to a superheated fluid having a temperature greater than 5° C., comprising the steps of passing the natural gas under pressure through a train of first, second and third heat exchange stages in series in which the natural gas is heated.

2. A method according to claim 1, wherein each main heat exchange stage is heated by a condensing heat exchange medium.

3. A method according to claim 2, wherein composition of the heat exchange medium is the same in each main heat exchange stage, different condensing pressures being employed so as to give a required gradation in the natural gas outlet temperature of each main heat exchange stage in the series.

4. A method according to claim 1, wherein the first and second main heat exchange stages are heated by a condensing heat exchange medium, and the third heat exchange stage being heated by a liquid medium which does not change phase in the third main heat exchange stage.

5. A method according to claim 4, wherein the liquid medium which does not change phase comprises at least one of water or a mixture of water and glycol.

6. A method according to claim 2, wherein the condensing heat exchange medium comprises propane.

7. A method according to claim 2, wherein each main heat exchange stage that is heated by a condensing heat exchange medium has the heat exchange medium flow in an endless circuit comprising in addition to the main heat exchange stage, a vessel for collecting condensed heat exchange medium from the main heat exchanger, at least one subsidiary heat exchanger for revaporising the condensed heat exchange medium and a pump for pressurising a flow of the condensed heat exchange medium, the pump being located intermediate an outlet from the collection vessel and the subsidiary heat exchanger.

8. A method according to claim 7, wherein two heat exchange circuits share a common collection vessel.

9. A method according to claim 7, wherein the heat exchange circuits that include the first and second main heat exchange stages use subsidiary heat exchangers heated by sea water.

10. A method according to claim 9, wherein the sea water flows in open cycle.

11. A method according to claim 5, wherein thermal energy for heating the third main heat exchanger is recovered from waste heat or is produced by a heat pump.

12. A method according to claim 5, wherein the liquid medium that does not change phase flows in closed cycle.

13. A method according to claim 7, wherein the heat exchange circuit that includes the first heat exchanger uses at least two subsidiary heat exchangers in parallel to meet the thermal load on it.

14. A method according to claim 1, wherein the natural gas is raised to a temperature in the range of minus 40° C. to minus 20° C. in the first main heat exchange stage, to a temperature in the range minus of 5° C. to plus 5° C. in the second main heat exchange stage and to a temperature in the range of plus 10° C. to plus 25° C. in the third heat exchange stage.

15. A method according to claim 1, wherein the third main heat exchange stage meets 5% or less of the thermal load required to heat the natural gas to a desired temperature.

16. Apparatus for converting liquefied gas to a superheated fluid having a temperature greater than 5° C., comprising a train of first, second and third main heat exchanger stages in series.

17. Apparatus according to claim 16, employing a plurality of said trains in parallel.

18. Apparatus according to claim 17, wherein two of said trains share a third main heat exchange stage.

19. Apparatus according to claim 17, wherein two of said trains share second and third main heat exchange stages.

20. Apparatus according to claim 17, wherein any number of said trains share any number of third main heat exchange stages.

21. Apparatus according to claim 17, wherein any number of said train share any number of second and third main heat exchange stages.

22. Apparatus according to claim 16, wherein said apparatus is located aboard a sea going vessel.
